(19) United States
(12) Patent Application Publication
(10) Pub. No.: US 2026/0219609 A1
(43) Pub. Date: Jul. 30, 2026

(54) FIXING DEVICE

(71) Applicant: Konica Minolta, Inc., Tokyo (JP)

(72) Inventor: Kohei SUGAWARA, Aichi (JP)

(21) Appl. No.: 19/454,338

(22) Filed: Jan. 20, 2026

(30) Foreign Application Priority Data
Jan. 28, 2025 (JP) 2025-012159

(51) Int. Cl. G03G 15/20

(52) U.S. Cl. CPC G03G 15/2053; G03G 15/2064

(57) ABSTRACT

The fixing device includes a belt that conveys a recording medium, a support member that supports the belt, an facing member that is disposed to face the support member with the belt therebetween and forms a nip portion applying pressure to the belt and the recording medium between the facing member and the support member, and a sliding portion on which the belt slides at a pressure lower than that at the nip portion. When L1 is defined as a Rockwell hardness of a sliding portion-side surface of the belt and L2 is defined as a Rockwell hardness of a belt-side surface of the sliding portion, a hardness ratio L2/L1 is 0.8 or more and 1.4 or less.

### CROSS REFERENCE TO RELATED APPLICATIONS

The entire disclosure of Japanese Patent Application No. 2025-012159, filed on Jan. 28, 2025 is incorporated herein by reference in its entirety.

### BACKGROUND

### Technological Field

The present invention relates to a fixing device.

### Description of Related Art

In the related art, a fixing device is known in which a recording medium on which a toner image is formed is interposed between a rotatable endless belt and a pressing member, and is pressurized and heated to fix the toner image to the recording medium.

As such a fixing device, for example, PTL 1 (Japanese Unexamined Patent Application Publication No. 2020-204670) discloses a fixing device including an endless belt, a fixing pad, a heater, and a pressure roller disposed to face the fixing pad with the belt interposed therebetween. In such a fixing device, a belt traveling while being guided by a side plate flange (not illustrated) is pressed and held between the fixing pad and the pressure roller to form a nip portion. The toner image is fixed onto a recording medium by passing the recording medium through the nip portion.

In such a fixing device, usually, a lubricant is supplied to an inner peripheral surface of the belt in order to reduce sliding resistance of the belt. Here, since a high load is applied to a portion (constituting the nip portion) of the fixing pad by pressing, wear powder is more likely to be generated due to wear of the fixing pad or the belt over time, and the wear powder is mixed into the lubricant to increase the viscosity of the lubricant, thereby increasing the rotational torque of the belt in some cases. Therefore, PTL 1 discloses that the hardness of the surface of the nip forming portion of the fixing pad is made higher than the hardness of the inner peripheral surface of the belt by a predetermined degree or more.

### SUMMARY

However, the method of PTL 1 cannot sufficiently suppress an increase in the rotational torque of the belt.

That is, in the fixing device as described above, there is a portion where the belt slides at a pressure lower than that at the nip portion. For example, the belt slides on the periphery of a portion (that constitutes the nip portion) in the guide surface of the fixing pad or a guide member that guides the travel of the belt with a load lower than that of the nip portion.

According to studies by the present inventors, it has been found that in such a region (sliding portion) where the belt slides with a low load, wear of the sliding portion or the belt is liable to occur by a mechanism different from that in a region such as the nip portion where the belt slides with a high load, so that the rotational torque of the belt is liable to increase and the durability of the sliding portion or the belt is liable to lower. In the method of PTL 1, wear of a region in which the belt slides under a low load is not considered, and an increase in rotational torque of the belt cannot be sufficiently suppressed.

The present invention has been made in consideration of the above-described circumstances, and an object of the present invention is to provide a fixing device capable of suppressing wear in a region where a belt slides under a low load and sufficiently reducing an increase in rotational torque of the belt.

The present invention relates to the following fixing devices.
[1] A fixing device for fixing a toner image formed on a recording medium, the fixing device including:
a belt that conveys the recording medium; a support that supports the belt; a facing member that is disposed to face the support with the belt interposed between the facing member and the support and forms a nipper that applies pressure to the belt and the recording medium between the facing member and the support; and a slider on which the belt slides at a pressure lower than that of the nip portion, in which
when L1 is defined as a Rockwell hardness of a surface of the belt and L2 is defined as a Rockwell hardness of a surface of the slider, a hardness ratio L2/L1 is 0.8 or more and 1.4 or less, the surface of the belt being located on a side of the slider, the surface of the slider being located on a side of the belt.
[2] The fixing device according to [1], in which the slider includes a guide portion that guides traveling of the belt.
[3] The fixing device according to [1] or [2], in which when L3 is defined as a Rockwell hardness of a portion of the support, a hardness ratio L3/L1 is less than 1, the portion constituting the nipper.
[4] The fixing device according to [3], in which the hardness ratio L3/L1 is 0.9 or less.
[5] The fixing device according to any one of [1] to [4], in which the slider includes a base material and a coating layer disposed on the base material.
[6] The fixing device according to any one of [1] to [4], in which the slider includes a base material and a cover member disposed on the base material.

### BRIEF DESCRIPTION OF THE DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1 is a schematic cross-sectional view illustrating a schematic configuration of an image forming apparatus;

FIG. 2 is a schematic cross-sectional view illustrating a schematic configuration of the fixing device according to the first embodiment;

FIG. 3A is a schematic enlarged view of the periphery of a fixing pad, and FIG. 3B is a schematic view of the fixing pad when viewed from the guide surface side of a belt;

FIG. 4A is a schematic perspective view of a guide member and FIG. 4B is a schematic cross-sectional view of the guide member in a direction orthogonal to a longitudinal direction of the guide member;

FIG. 5A is a schematic perspective view of a guide member of a modification example, and FIG. 5B is a schematic cross-sectional view of the guide member in a direction orthogonal to a longitudinal direction of the guide member;

FIG. 6 is a schematic diagram illustrating a schematic configuration of the fixing device of the second embodiment;

FIG. 7A is a schematic perspective view of a heater holder with a heater attached thereto, and FIG. 7B is a schematic cross-sectional view of the heater holder in a direction orthogonal to a longitudinal direction of the heater holder;

FIG. 8A is a schematic front view of a pair of guide members, FIG. 8B is a rear view of the guide members, and FIG. 8C is a schematic cross-sectional view taken along line 8C-8C of FIG. 8A;

FIGS. 9A and 9B are schematic diagrams illustrating a modification example of the heater holder;

FIGS. 10A to 10C are schematic diagrams illustrating a modification example of the guide member;

FIG. 11A and FIG. 11B are schematic diagrams illustrating a schematic configuration of a fixing device according to a modification;

FIG. 12A is an explanatory diagram illustrating a method for calculating a torque increase rate, and FIG. 12B is a graph illustrating a relationship between travel distances of belts and rotational torques of the belts in Examples and Comparative Examples; and

FIG. 13 is a simulation result showing the relationship between the ratio (hardness ratio L3/L1) and the life achievement rate—the ratio between the Rockwell hardness L3 of the nip portion (i.e., nipper) of the fixing pad and the Rockwell hardness L1 of the inner peripheral surface of the belt.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

### (1) Image Forming Apparatus

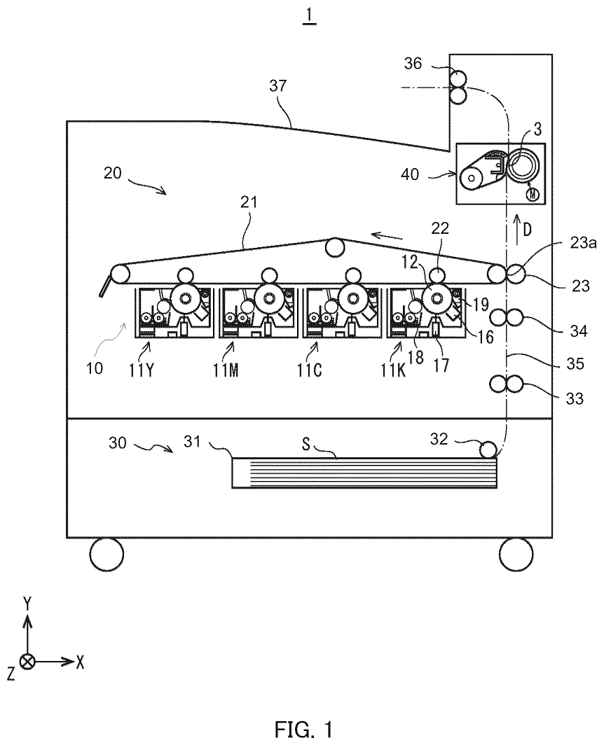

FIG. 1 is a schematic cross-sectional view illustrating a schematic configuration of an image forming apparatus 1 of the first embodiment.

As illustrated in FIG. 1, the image forming apparatus 1 includes an image forming section 10, a transfer section 20, a sheet feed section 30, and a fixing section 40.

The image forming section 10 includes image forming units 11Y, 11M, 11C, and 11K corresponding to respective colors of Y (yellow), M (magenta), C (cyan), and K (black).

The image forming unit 11K includes the photosensitive drum 12, and a charging section 16, an exposure section 17, a developing section 18, and a cleaner 19 which are disposed along a peripheral direction of the photosensitive drum 12.

The exposure section 17 includes a light emitting element, such as a laser diode, and lenses, and modulates laser light to expose and scan the photosensitive drum 12 in accordance with a drive signal from a controller (not illustrated).

The photosensitive drum 12 is rotationally driven by a drive source (not illustrated), and is uniformly charged by the charging section 16 after residual toner on the surface is removed by the cleaner 19 before being exposed to the above-described light. When the photosensitive drum 12 is exposed to the above-described laser light in such a uniformly charged state, an electrostatic latent image is formed on the surface of the photosensitive drum 12. The electrostatic latent image formed on the photosensitive drum 12 is developed by the developing section 18, whereby a toner image in the K color is formed on the surface of the photosensitive drum 12.

The transfer section 20 includes an intermediate transfer belt 21, a primary transfer roller 22, and a secondary transfer roller 23. The K-color toner is primarily transferred from the photosensitive drum 12 onto the intermediate transfer belt 21 by the primary transfer roller 22 disposed opposite to the photosensitive drum 12 with the intermediate transfer belt 21 circulating therebetween.

The image forming units 11Y, 11M, and 11C are also configured similarly to the image forming unit 11K. Next, for each of the image forming units, a toner image in a corresponding color (Y, M, or C) is formed on the photosensitive drum 12 and is primarily transferred onto the intermediate transfer belt 21 by the primary transfer roller 22.

The imaging operations in the image forming units 11Y to 11K are performed at different timings so that the toner images are primarily transferred to the same position on the intermediate transfer belt 21 in a superimposed manner. Y to K toner images are thus formed on intermediate transfer belt 21.

The sheet feed section 30 includes a sheet feeding cassette 31 for accommodating recording media S, a feeding roller 32, a conveying roller 33, and a timing roller 34.

The feeding roller 32 comes into contact with the uppermost recording media S in the sheet feeding cassette 31 and feeds the recording media to the conveyance path 35. The conveyance roller 33 conveys the recording media S fed by the feeding roller 32 toward the timing roller 34. The timing roller 34 feeds the recording media S to the downstream side at a timing instructed from the controller (not illustrated).

The toner images superimposed and transferred onto the intermediate transfer belt 21 are moved to a secondary transfer position 23a, which is a contact position between the intermediate transfer belt 21 and the secondary transfer roller 23, by the circulation of the intermediate transfer belt 21.

In synchronization with the movement timing of the toner image on the intermediate transfer belt 21, recording media S are fed on a conveyance path 35 from a timing roller 34 of the sheet feed section 30, and when recording medium S passes through the secondary transfer position 23a, the toner image on the intermediate transfer belt 21 is secondarily transferred onto recording medium S by a secondary transfer roller 23. The recording medium S that has passed through the secondary transfer position 23a is sent to the fixing section 40.

The fixing section 40 allows the recording medium S having been conveyed from the secondary transfer roller 23 in the direction indicated by arrow D (conveyance direction of the recording medium) to pass through the fixing nip 3 to heat and press the toner image (unfixed image) on the recording medium S, thereby fixing the toner image on the recording medium S.

The recording medium S that has passed through the fixing section 40 is discharged to the outside of the apparatus by a discharge roller 36 and is stored in a discharge tray 37.

### (2) Fixing Section 40 (Fixing Device)

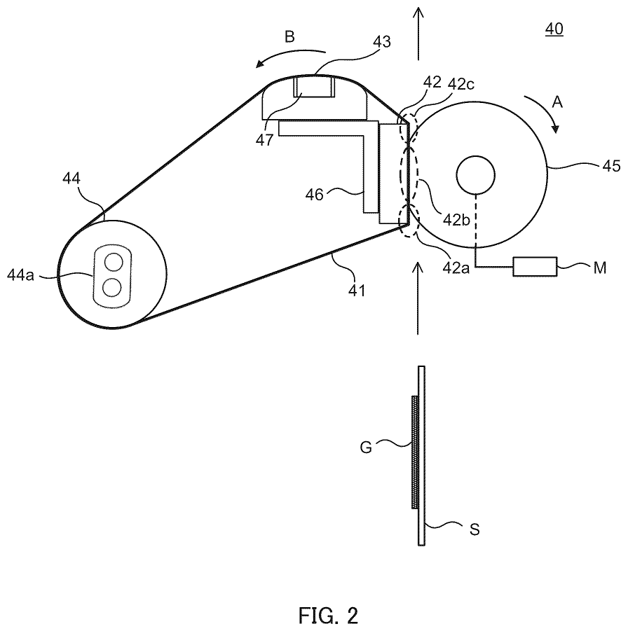

FIG. 2 is a schematic cross-sectional view illustrating a schematic configuration of the fixing device 40 of the present embodiment.

As illustrated in FIG. 2, the fixing device 40 may include an endless belt 41, a fixing pad 42 (support member (i.e., support)) that supports the belt 41 so that the belt 41 can travel, a guide member (i.e., guide) 43, a heating roller 44, and a pressure roller 45 (facing member) that drives the belt 41.

The endless belt 41 is a member that conveys the recording medium S. The belt 41 is wound around the fixing pad 42, the guide member 43, and the heating roller 44, and tension acts on the belt 41 as the heating roller 44 is urged in a direction away from the fixing pad 42 by an elastic member (not illustrated) such as a spring. The belt 41 is rotated by the rotation of the pressure roller 45 in a direction (belt circulating direction) indicated by an arrow B.

The endless belt 41 includes, for example, a base layer, an elastic layer, and a surface layer in this order from the inner peripheral surface side. The material of the base layer may be, for example, a resin material such as polyimide resin, polyamide-imide resin, or the like. The material of the elastic layer may be a heat-resistant elastic material such as silicone rubber or fluororubber. The material of the surface layer may be a releasable resin material such as a fluororesin (e.g., PFA (tetrafluoroethylene-perfluoroalkyl vinyl ether copolymer) or PTFE (polytetrafluoroethylene resin)).

The base layer preferably has a thickness of, for example, 5 to 100 μm. The elastic layer preferably has a thickness of, for example, 10 to 300 μm. The thickness of the surface layer is, for example, preferably 5 to 100 μm. The inner diameter of the belt 41 may be, for example, 10 to 100 mm.

The fixing pad 42 (support member) is disposed on the inner peripheral side of the belt 41 so as to face the pressure roller 45 and supports the belt 41. The fixing pad 42 is supported and fixed by a bracket 46. The bracket 46 is a member made of metal such as aluminum, iron, or SUS.

The fixing pad 42 includes an upstream guide portion (sliding portion (i.e., slider)) 42a, a pressed portion 42b, and a downstream guide portion (sliding portion (i.e., slider)) 42c in this order along the belt circulating direction (see FIG. 2).

The upstream guide portion 42a is disposed upstream of the pressed portion 42b in the belt circulating direction, and guides the belt 41 to the pressed portion 42b immediately before entering the pressed portion 42b.

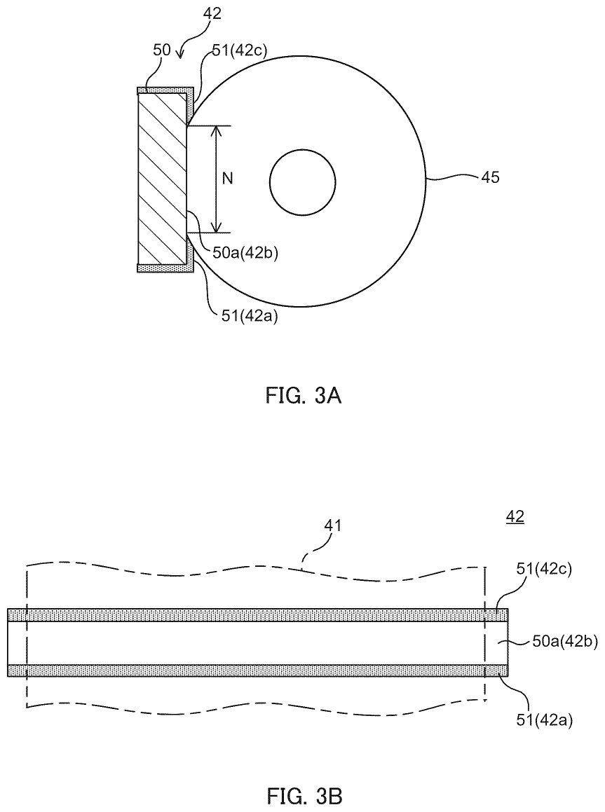

The pressed portion 42b is a portion constituting the nip portion N of the fixing pad 42, and receives a pressing force generated between the fixing pad 42 and the pressure roller 45. In the present embodiment, the pressure roller 45 presses the fixing pad 42 via the belt 41 and the pressed portion 42b receives the pressure. Thus, between the fixing pad 42 and the pressure roller 45, the belt 41 and recording medium S (on which the toner images are formed) are pressed, and between the belt 41 and the pressure roller 45, the nip portion N is formed (see FIG. 3A).

The downstream guide portion 42c guides the belt 41 immediately after passing through the pressed portion 42b to the downstream side in the belt circulating direction.

The guide member 43 (sliding member) is disposed on the inner peripheral side of the belt 41, side by side with the fixing pad 42, along the circulating direction of the belt 41, and guides the travel of the belt 41. Note that the guide member 43 may be fixed by the bracket 46 common to the fixing pad 42. In the present embodiment, the guide member 43 includes a lubricant supplying member 47 and applies a lubricant to the inner peripheral surface of the belt 41.

The lubricant supplying member 47 holds, for example, a lubricant, and applies the lubricant to the inner peripheral surface of the belt 41 by bringing the upper surface of the lubricant supplying member 47 into contact with the inner peripheral surface of the belt 41. The lubricant supplying member 47 is made of a material suitable for retaining a lubricant, for example, a fibrous material such as aramid fiber or fluorine fiber, or a porous material such as silicon sponge. Here, an elastically deformable member is used, but it is not limited thereto.

As the lubricant, a fluorine-based or silicon-based lubricant having high heat resistance is desirable. Specifically, the lubricant includes a base oil (for example, a fluorine-based oil such as perfluoropolyether (PFPE), a silicone oil, or the like) and an additive, and may further include a thickener (for example, a solid lubricant, PTFE, or the like). By further including the solid lubricant, for example, when the coating layers 51 and 53, which will be described later, are worn, the slidability of the worn surface can be enhanced by the solid lubricant, and therefore, an increase in the rotational torque of the belt 41 can be more easily suppressed. Note that the lubricant containing the thickener is also referred to as grease.

The heating roller 44 is a hollow cylindrical member and incorporates a heat source 44a therein. Then, heat transmitted from the heating roller 44 heats the belt 41 to a predetermined temperature. The heat source 44a is, for example, a halogen heater, but is not limited thereto, and may be a resistance heating element or induction heating (IH). The heating roller 44 may rotate following the rotation of the belt 41. Alternatively, the heating roller 44 may be kept stationary and the belt 41 may slide on the surface of the heating roller 45.

The pressure roller 45 is disposed opposite to the fixing pad 42 with the belt 41 interposed therebetween. Next, between the pressure roller 45 and the fixing pad 42, the pressure roller 45 forms a nip portion N that applies pressure to the belt 41 and the recording media S (on which the toner images have been formed). In the present embodiment, the pressure roller 45 forms the nip portion N by pressing the fixing pad 42 via the belt 41. The pressure roller 45 is rotationally driven by a drive motor M in a direction indicated by arrow A.

The pressure roller 45 includes, for example, a core metal, an intermediate layer, and a surface layer. The core metal is made of, for example, aluminum or iron, and the core metal is preferably 2 to 3 mm thick, for example. The core metal may have a pipe-shape with a thickness of 0.1 to 10 mm, or may have an irregular cross-sectional shape such as a three-arrow shape. The intermediate layer is an elastic layer and can be formed of a material having heat resistance and elasticity such as silicone rubber or fluororubber. The intermediate layer is preferably about 2 to 5 mm thick, for example. The surface layer can be formed of a material having a releasing property such as a fluororesin. The surface release layer is preferably about 20 to 80 μm thick, for example.

Next, an operation of the fixing device 40 will be described.

The pressure roller 45 is rotated by the drive motor M. The belt 41 is driven to rotate by rotation of the pressure roller 45. The belt 41 is heated by the heating roller 44 while being rotated. After the belt 41 is heated to a predetermined temperature, the recording medium S on which a toner image G is formed is caused to enter the nip portion N. While the recording medium S passes through the nip portion N, the toner image G is fixed to the recording medium S by heat and pressure.

Here, on the surfaces of the upstream guide portion 42a and the downstream guide portion 42c of the fixing pad 42 and the guide member 43, the belt 41 slides at a pressure lower than the pressure received by the belt 41 at the nip portion N. That is, the sliding resistance (frictional resistance) is smaller on the surfaces of the upstream guide portion 42a and the downstream guide portion 42c of the fixing pad 42 and the guide member 43 than at the nip portion N. According to the studies of the present inventors, it has been found that, on the surface of the sliding portion on which the belt 41 slides at such a low pressure, the belt 41 and the sliding portion (in particular, the sliding portion) are more likely to be worn by a mechanism different from that at the nip portion N, and the rotational torque of the belt 41 due to wear powder is more likely to increase.

Specifically, there is a lubricant between the surface of the fixing pad 42 and the inner peripheral surface of the belt 41 and the surface of the belt member 43 and the inner peripheral surface of the belt 41. Here, since a high pressure is applied to the nip portion N (high load portion), the film thickness of the lubricant is small, and a boundary lubrication state or a mixed lubrication state is formed. In this case, both adhesive wear and abrasive wear occur. In particular, since the contact area between the sliding member and the belt is large and the amount of adhesion is large, adhesive wear is more likely to be dominant.

On the other hand, at the sliding portions (the upstream guide portion 42a, the downstream guide portion 42c, and the guide member 43; low load portions) where the belt 41 slides at a pressure lower than that at the nip portion N, the film thicknesses of the lubricant are large, so that the contact area between each sliding member and the belt is small. Therefore, the contact load is more likely to vary, and fine protrusions on the surface of the low load portion are more likely to be scraped at a portion where the contact load is large, and abrasive wear is more likely to be dominant. Abrasive wear causes wear on the belt 41 and the sliding portions (especially the sliding portions), and the resulting friction powder gets mixed into the lubricant, which tends to increase the rotational torque of the belt 41.

Therefore, in the present embodiment, the hardness of the inner peripheral surface of the belt 41 (the surface of the base layer of the belt 41 in the present embodiment) and the hardness of the surface of the sliding portion on the belt 41 side are made substantially equal to each other. Specifically, when the Rockwell hardness of the inner peripheral face of the belt 41 is L1 and the Rockwell hardness of the surfaces of the upstream guide portion 42a and the downstream guide portion 42c of the fixing pad 42 and the guide member 43 each disposed on the side of the inner peripheral of the belt 41 is L2, the hardness ratio L2/L1 is set to be 0.8 or more and 1.4 or less.

When the hardness ratio L2/L1 is 0.8 or more, abrasive wear of the inner peripheral surface side of the sliding portion can be suppressed, thus suppressing an increase in the viscosity of the lubricant due to entry of wear powder. As a result, an increase in the rotational torque of the belt 41 can be suppressed. On the other hand, when the hardness ratio L2/L1 is equal to or less than 1.4, it is possible to suppress abrasive wear of the inner peripheral surface of the belt 41, and thus it is possible to suppress an increase in the rotational torque of the belt 41 due to the mixing of wear powder. From the same viewpoint, the hardness ratio L2/L1 is more preferably 0.9 or more and 1.25 or less.

The Rockwell hardness L2 of the surface of the sliding portion depends on the Rockwell hardness L1 of the inner peripheral surface of the belt 41, but can be, for example, 60 or more and 120 or less, preferably 90 or more and 110 or less.

The Rockwell hardness of the surfaces of the belt 41 and the sliding portions can be measured by storing these components in a room at 25° C. for one day, and then measuring the M-scale Rockwell hardness of the surfaces (sliding surfaces) of these components using a Rockwell tester (for example, RMT-X manufactured by Matsuzawa Co., Ltd.) at 25° C. and 65% RH in accordance with JIS K 7202-2:2001. The measurement can be performed by selecting any five positions at 50 mm intervals on the sliding surface and calculating the average value thereof.

The Rockwell hardness of the surface of the belt 41 or the sliding portion can be adjusted by selecting the material of the belt 41 or the sliding portion or by covering the surface of the belt 41 or the sliding portion with a coating layer or a cover member (i.e., cover). In the case where the surface of the belt 41 or the sliding portion is covered with a coating layer or a cover member, the hardness of the surface of the coating layer or the cover member can be adjusted by the type of the resin contained therein or the type and content of the filler. In addition, when the resin is a curable resin, the hardness can also be adjusted by curing conditions and the like. Hereinafter, the sliding portions (in the present embodiment, the guide portions 42a and 42b of the fixing pad 42 and the guide member 43) constituting the low load portion will be described in detail. Hereinafter, an example will be described in which the hardness ratio L2/L1 is adjusted by providing a coating layer on the surfaces of the guide portions 42a and 42b of the fixing pad 42 and the guide member 43, but the method of adjusting the hardness is not limited to this.

### (3) Low Load Portion

### (3-1) Upstream Guide Portion 42a and Downstream Guide Portion 42c of Fixing Pad 42

FIG. 3A is a schematic enlarged view of the periphery of the fixing pad 42, and FIG. 3B is a schematic view of the fixing pad 42 as viewed from the side of the guide surface for the belt 41.

As shown in FIG. 3A, the fixing pad 42 includes a base material 50 and a coating layer 51 disposed on a guide surface (sliding surface) 50a of the base material 50.

The base material 50 can be made of any material, and is preferably made of a material having heat insulating properties and heat resistance. The base material 50 may be formed of a resin material containing a heat-resistant resin such as, polyimide (PI), polyphenyl sulfide (PPS), liquid crystal polymer (LCP), or the like, or may be formed of a metal material such as aluminum or iron, a ceramic material, or the like, or may be a composite of any of these with silicone rubber, fluororubber, or the like.

The coating layer 51 is disposed in a strip shape on at least the upstream and downstream ends of the guide surface 50a of the base material 50 in the circulating direction of the belt 41, respectively. As a result, the coating layer 51 forms the upstream guide portion 42a and the downstream guide portion 42c described above. In the present embodiment, the guide surface 50a of the base material 50 is exposed between the pair of coating layers 51, and forms the pressed portion 42a described above (see FIGS. 2 and 3A). The coating layer 51 may be disposed continuously over the entire guide surface 50a of the substrate 50, or another coating layer (not illustrated) may be disposed between a pair of coating layers 51.

The material of the coating layer 51 is not particularly limited as long as the hardness ratio L2/L1 satisfies the above-described range. For example, the coating layer 51 may include a cured product of a composition including a slidable resin or a thermosetting composition including a thermosetting resin.

Examples of the slidable resin include polytetrafluoroethylene (PTFE), tetrafluoroethylene-perfluoroalkyl vinyl ether copolymer (PFA), polyamide-imide (PAI), polyether ether ketone (PEEK), polyimide (PI), polyphenyl sulfide (PPS), liquid crystal polymer (LCP), polyester (e.g., polyethylene terephthalate (PET)), ultrahigh molecular weight polyethylene, and MC nylon. Examples of the thermosetting resin include a phenol-based resin and an epoxy resin.

The curing agent cures the thermosetting resin. For example, as a curing agent for a phenol resin, hexamethylenetetramine, a polyacetal resin, and the like can be given.

These compositions may further contain, as necessary, other thermosetting resins such as an epoxy resin, a filler, a silane coupling agent, a colorant, a flame retardant, a release agent, and the like. Among these, from the viewpoint of easily adjusting the hardness ratios L2/L1 and L3/L1, it is preferable to include a filler.

The filler may be an organic filler or an inorganic filler. Examples of the organic filler include resin fillers such as fluororesin, polyimide, and polyphenylene sulfide, and carbon fillers such as graphite and carbon. Examples of the inorganic filler include powdery fillers such as glass beads, glass balloons, glass powder, calcium carbonate, talc, silica, aluminum hydroxide, clay, mica, graphite, and carbon black, and fibrous fillers such as glass fibers and carbon fibers.

The content of the filler in the composition is not particularly limited as long as the Rockwell hardness of the surface of the coating layer 51 satisfies the hardness ratio L2/L1 described above, but can be, for example, 50 mass % or less (preferably 5 mass % or more and 50 mass % or less) relative to the total mass of the composition.

The thickness of the coating layer 51 is not particularly limited, but can be, for example, 10 μm or more and 30 μm or less, preferably 15 μm or more and 25 μm or less. When the thickness of the coating layer 51 is within the above range, warpage or the like can be made less likely to occur.

The coating layer 51 can be formed, for example, by applying a composition containing a slidable resin to a predetermined portion of the guide surface 50a of the base material 50, or by applying a thermosetting composition containing a thermosetting resin and then heating to cure harden the thermosetting composition. When the coating layer 51 is formed by applying a thermosetting composition containing a thermosetting resin, the hardness of the surface of the coating layer 51 can be adjusted by adjusting the heating temperature, the heating time, and the like. In addition, the hardness of the surface of the coating layer 51 can be adjusted by the content of the filler.

### (3-2) Guide Member 43

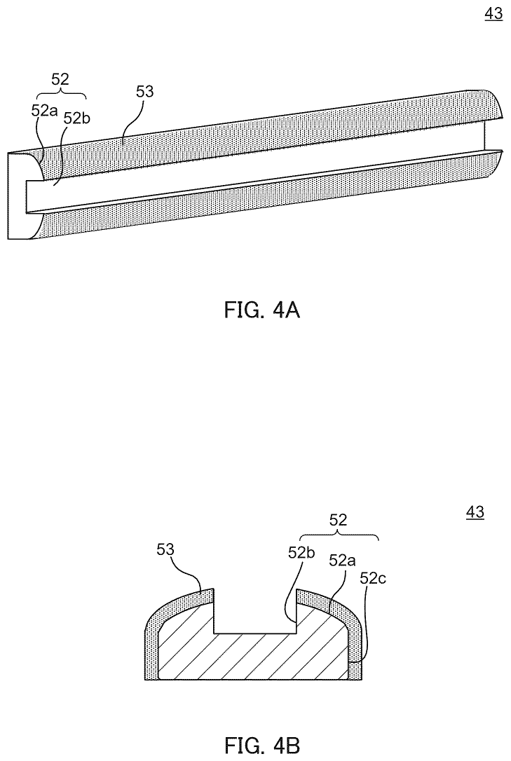

FIG. 4A is a schematic perspective view of a guide member 43, and FIG. 4B is a schematic cross-sectional view of the guide member 43 in a direction orthogonal to a longitudinal direction of the guide member 43.

As illustrated in FIGS. 4A and 4B, the guide member 43 includes a base material 52 and a coating layer 53 disposed on a guide surface 52a of the base material 52.

The base material 52 has an arc-shaped cross-sectional shape in which the guide surface 52a is convex upward. In the base material 52, a groove portion 52b along the width direction of the belt 41 is disposed on a guide surface 52a on which the belt 41 slides. The same material as the material of the base material 50 of the fixing pad 42 can be used as the material of the base 52. Among these, a resin material containing the above-described resin having high heat insulating properties is preferable.

The coating layer 53 is disposed at least on the guide surface 52a of the base material 52. The coating layer 53 may also be disposed on both side surfaces 52c continuing from the guide surface 52a (see FIG. 4B). The coating layer 53 does not have to be provided inside the groove portion 52b. The materials and thicknesses of the coating layer 53 may be the same as the materials and thicknesses of the coating layer 51.

Next, a specific description will be given of the portion that constitutes the nip portion N (high load portion) (in the present embodiment, the pressed portion 42b of the fixing pad 42).

### (4) High Load Portion (Pressed Portion 42b of Fixing Pad 42)

As described above, at the nip portion N, the belt 41 receives high pressures and slides (refer to FIG. 3A). Therefore, at the nip portion N, the inner peripheral surface of the belt 41 is liable to be worn by the adhesive wear. Therefore, the thickness of the belt 41 is more likely to be reduced, and the durability of the belt 41 is more likely to deteriorate. Therefore, it is desired that wear of the inner peripheral surface of the belt 41 can be suppressed at the nip portion N.

Therefore, it is preferable that the Rockwell hardness L3 of the surface of the pressed portion 42b of the fixing pad 42 is smaller than the hardness L1 of the inner peripheral surface of the belt 41. Specifically, the hardness ratio L3/L1 between the Rockwell hardness L3 of the surface of the pressed portion 42b of the fixing pad 42 and the hardness L1 of the inner peripheral surface of the belt 41 is preferably less than 1, and is preferably 0.9 or less. When the hardness ratio L3/L1 is less than 1, the wear on the inner peripheral surface of the belt 41 can be further suppressed. From the same viewpoint, the hardness ratio L3/L1 is more preferably 0.7 or more and 0.8 or less. When the hardness ratio L3/L1 is 0.7 or more, the surface of the sliding portion is prevented from being excessively worn away, and the generation of wear powder can be further reduced. The Rockwell hardness L3 of the surface of the pressed portion 42b can be measured by the same method as above.

In the present embodiment, the guide surface 50a of the base material 50 exposed between the pair of coating layers 51 constitutes the pressed portion 42b (see FIG. 3A and FIG. 3B). Therefore, it is preferable that the hardness ratio L3/L1 between the Rockwell hardness L3 of the guide surface 50a of the base material 50 and the Rockwell hardness L1 of the inner peripheral surface of the belt 41 satisfies the above range.

In the present embodiment, the hardness of the guide surface 50a of the base material 50 satisfies the above hardness ratio, but the present invention is not limited thereto. For example, another coating layer 53 may be disposed on the guide surface 50a of the base material 50, and the hardness ratio may be satisfied by the hardness of the other coating layer 53.

### (5) Action

As described above, in the present embodiment, the sliding portions (the upstream guide portion 42a and the downstream guide portion 42b of the fixing pad 42, and the guide member 43) include the coating layers 51 and 53 on the guide surfaces for the belt 41 (see FIG. 3A, FIG. 3B, FIG. 4A, and FIG. 4B)—on the sliding portions, the belt 41 slides at a pressure lower than that at the nip portion N. As a result, the hardness ratio L2/L1 between the hardness L2 of the surfaces of the coating layers 51 and 53 of the sliding portions and the hardness L1 of the inner peripheral surface of the belt 41 is 0.8 or more and 1.4 or less. Thus, abrasive wear of the sliding portions and the belt 41 can be suppressed, and increase of the rotational torque of the belt 41 due to mixing of friction powder into the lubricant can be sufficiently suppressed. That is, it is possible to provide the fixing device capable of suppressing the wear in the region where the belt slides with a low load and capable of reducing the increase in the rotational torque of the belt.

Further, in the present embodiment, the hardness ratio L3/L1 between the surface hardness L3 of the pressed portion 42b constituting the nip portion N and the hardness L1 of the inner peripheral surface of the belt 41 is less than 1. Thus, the adhesive wear of the inner peripheral surface of the belt 41 can be suppressed, and the durability of the belt 41 can be further enhanced.

### (6) Modification Example

In the above embodiment, the hardness ratio L2/L1 is adjusted by forming a coating layer on the upstream guide portion 42a and downstream guide portion 42c of the fixing pad 42 and the guide surface 43a of the guide member 43, but this is not limited to this. For example, the hardness ratio L2/L1 may be adjusted by covering the guide surface 43a of the guide member 43 with a cover member.

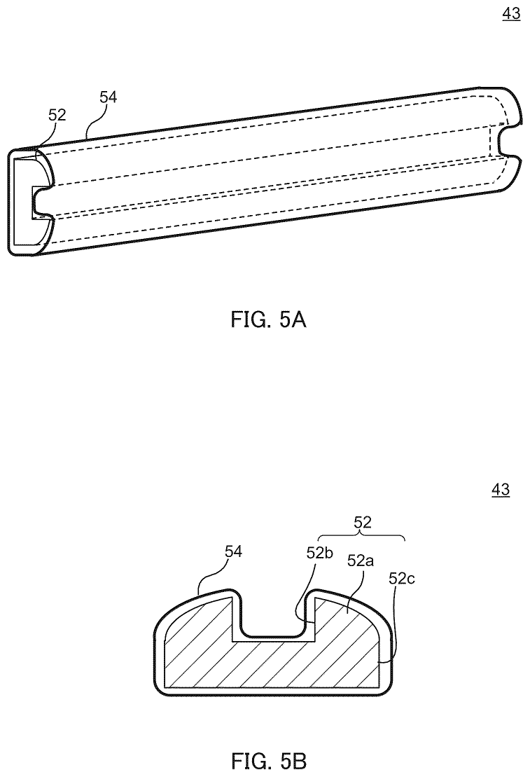

FIG. 5A is a schematic perspective view of a guide member 43 of a modification example, and FIG. 5B is a schematic cross-sectional view in a direction orthogonal to a longitudinal direction of the guide member 43.

As illustrated in FIGS. 5A and 5B, the guide member 43 includes a base material 52 and a cover member 54 that covers at least a guide surface 52a of the base material 52.

The cover member 54 may be any member as long as the hardness ratio L2/L1 satisfies the above range. For example, the cover member 54 may be a sheet or the like of a composition containing the above-described slidable resin. The sheet may have an endless shape. The thickness of the cover member 54 is not particularly limited, but is, for example, less than 500 μm, and preferably 100 μm or more and 300 μm or less from the viewpoints of the assemblability and the followability.

In the above-described embodiment, the upstream guide portion 42a and the downstream guide portion 42c of the fixing pad 42 and the guide member 43 all satisfy the hardness ratio L2/L1, but the present invention is not limited thereto. For example, at least one of the guide member 43 and the upstream guide portion 42a and the downstream guide portion 42c of the fixing pad 42, preferably, the guide member 43 may satisfy the hardness ratio L2/L1. In addition, in a case where the belt 41 slides on the heating roller 43, the Rockwell hardness of the heating roller 43 may also satisfy the hardness ratio L2/L1.

Further, in the above-described embodiment, the belt 41 includes the base layer, the elastic layer, and the surface layer, but is not limited thereto. For example, the belt 41 may include an base material, an inner peripheral layer disposed on the inner circumference of the base material, and an outer peripheral layer disposed on the outer circumference of the base material. In this case, the material of the base material may be a metallic material such as nickel, cupper, or stainless steel, or a rubber material such as silicone rubber. The materials of the inner peripheral layer and the outer peripheral layer may be resins such as fluororesins, polyamide-imide resins (PAI), and polyimide resins (PI). Further, a four layer structure of an sliding layer, a base layer, an elastic layer, and a surface layer may be employed. In such a case, a metal material such as SUS or nickel may be used for the base layer. Note that a two layer structure of a base layer and a surface layer may also be employed.

### Second Embodiment

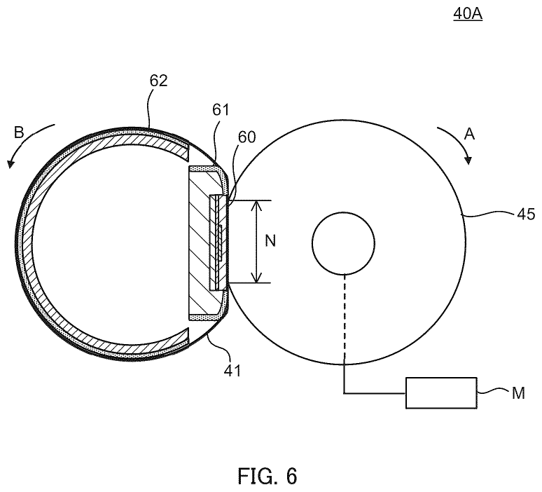

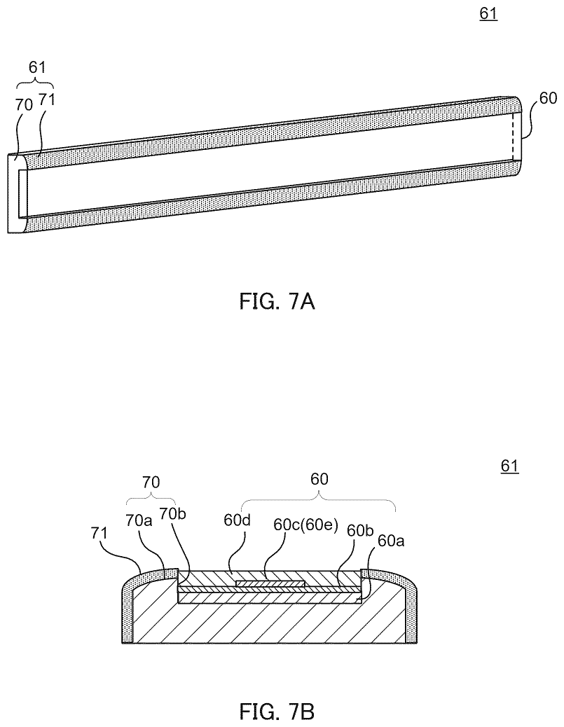

FIG. 6 is a schematic diagram illustrating a schematic configuration of a fixing device 40A of the second embodiment. In FIG. 6, constituent elements denoted by the same reference signs as those illustrated in FIGS. 1 to 5 have the same or similar functions, and detailed description of the constituent elements is omitted, and the same applies to the following FIGS. 7 to 11. In FIG. 6, for the sake of convenience, only a part is shown as a cross-sectional view.

The fixing device 40A of the present embodiment includes a heater 60, a heater holder 61, and a pair of guide members 62, instead of the guide member 43 and the heating roller 44 of the fixing device 40 described above.

### (1) Heater 60 and Heater Holder 61

FIG. 7A is a schematic perspective view of the heater holder 61 with the heater 60 attached thereto, and FIG. 7B is a schematic cross-sectional view of the heater holder 61 in a direction orthogonal to the longitudinal direction of the heater holder 61.

The heater 60 is a heating member that heats the belt 41. In the present embodiment, the heater 60 includes a plate-shaped base board 60a, a first insulating layer 60b, a conductive layer 60c, and a second insulating layer 60d in this order (see FIG. 7B). Furthermore, the conductor layer 60c includes a heat generating portion 60e that generates heat by energization.

The base board 60a is made of, for example, a metal material such as stainless steel (SUS), iron, or aluminum. The material of the base board 60a is not limited to a metal material, and may be ceramic, glass, or the like. When the base board 60a is made of an insulating material such as ceramic, the first insulating layer 60a can be omitted.

The insulating layers 60b and 60d are made of, for example, an insulating material such as heat-resistant glass, ceramic, or polyimide. In the present embodiment, the heat generating portion 60e is disposed closer to the pressure roller 45 than the base board 60a is, but the base board 60a may be disposed closer to the pressure roller 45 than the heat generating portion 60e is. In such a case, the base board 60a is preferably made of a material having high thermal conductivity, such as aluminum nitride.

Note that in the present embodiment, the heater 60 is disposed so as to be in direct contact with the inner peripheral surface of the belt 41 in order to increase the efficiency of heat transfer to the belt 14, but the present invention is not limited to this. For example, the heater 60 may be disposed so as not to be in contact with the belt 41. The heater holder 61 is disposed on the inner peripheral surface side of the belt 41 and holds the heater 60.

The heater holder 61 includes a base material 70 and a coating layer 71 disposed on the guide surface 70a of the base material 70.

In the base material 70, the groove portion 70b along the width direction of the belt 41 is disposed on the guide surface 70a on which the belt 41 slides. The material of the base material 70 may be the same as the material of the base material 50 of the fixing pad 42. In particular, since the base material 70 is more likely to reach high temperatures due to the heat from the heater 60, it is preferable that the base material 70 be made of a heat-resistant material, such as LCP or PEEK.

The coating layer 71 is disposed on at least the guide surface 70a of the base material 70. The coating layer 71 may also be disposed on both side surfaces 70a continuing from the guide surface 70c. The coating layer 71 does not have to be provided inside of the groove portion 62b. The materials and thicknesses of the coating layer 71 may be the same as those of the coating layer 51 described above.

### (2) Pair of Guide Members 62

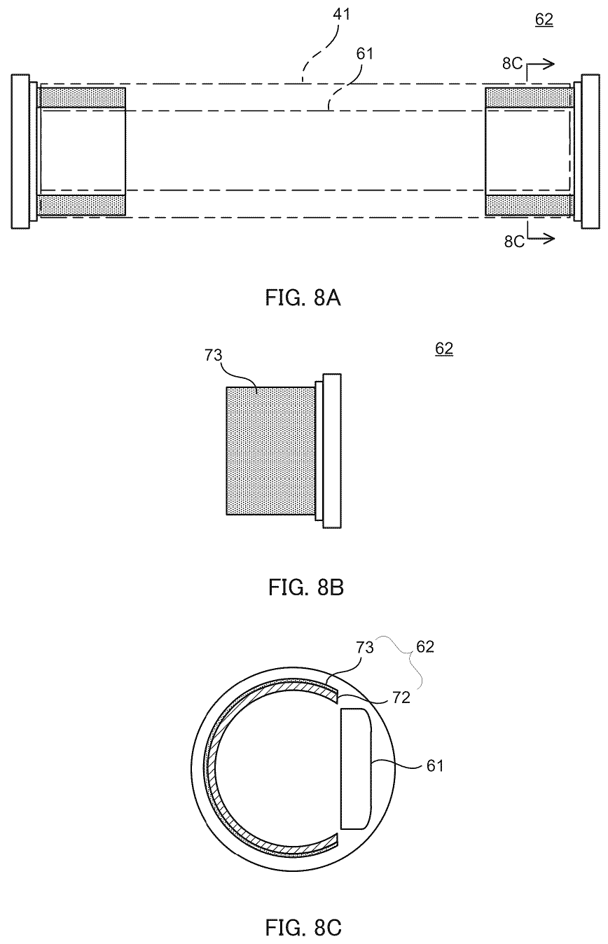

FIG. 8A is a schematic front view of a pair of guide members 62, FIG. 8B is a rear view of the guide members 62, and FIG. 8C is a schematic cross-sectional view taken along line 8C-8C of FIG. 8A. In FIG. 8C, hatching of the heater holder 61 is omitted for the sake of simplicity.

The pair of guide members 62 support the belt 41 at both end portions of the belt 41 (refer to FIG. 8A). The pair of guide members 62 restricts meandering of the belt 41 while guiding the belt 41, and therefore, are also referred to as meandering restriction members.

The pair of guide members 62 includes a base material 72 including a flange portion and a coating layer 73 disposed on a guide surface 72a of the base material 72 (refer to FIG. 8B and FIG. 8C). The material and thickness of the coating layer 73 may be the same as the material and thickness of the coating layer 51 described above.

### (3) Action

As described above, in the present embodiment, the sliding portions (the heater holder 61 and the pair of guide members 62) include the coating layers 71 and 73 on the guide surface for the belt 41 (refer to FIG. 7A, FIG. 7B, and FIG. 8A to FIG. 8C)—on the sliding portions, the belt 41 slides at a pressure lower than that at the nip portion N. Thus, the hardness ratio L2/L1 between the hardness L2 of the coating layer of the sliding portion and the hardness L1 of the inner peripheral surface of the belt 41 satisfies the range of 0.8 or more and 1.4 or less. Thus, it is possible to suppress abrasive wear of the sliding portions and the belt 41 and to suppress an increase in rotational torque of the belt 41 due to mixing of friction powder into the lubricant.

### (4) Modification Example

In the above-described embodiment, the hardness ratio L2/L1 is adjusted by forming coating layers on the guide surfaces of the heater holder 61 and the pair of guide members 62, but the present invention is not limited thereto. For example, the hardness ratio L2/L1 may be adjusted by covering the guide surfaces of the heater holder 61 and the pair of guide members 62 with the cover member 74.

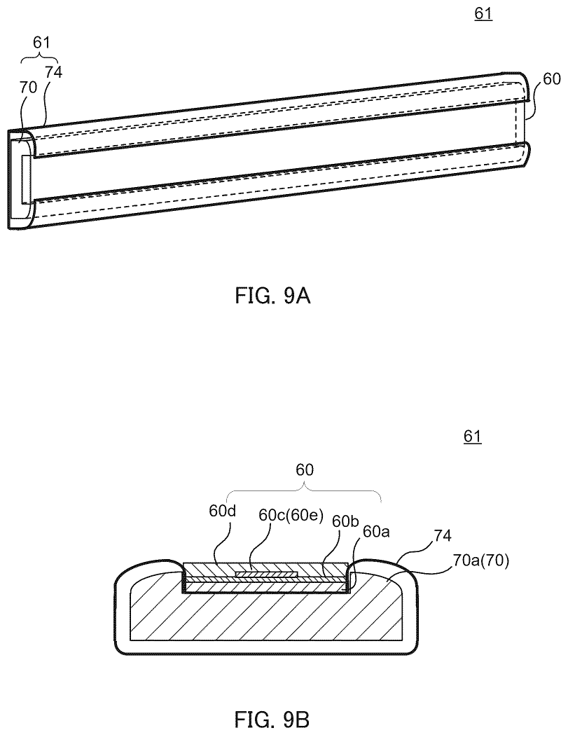

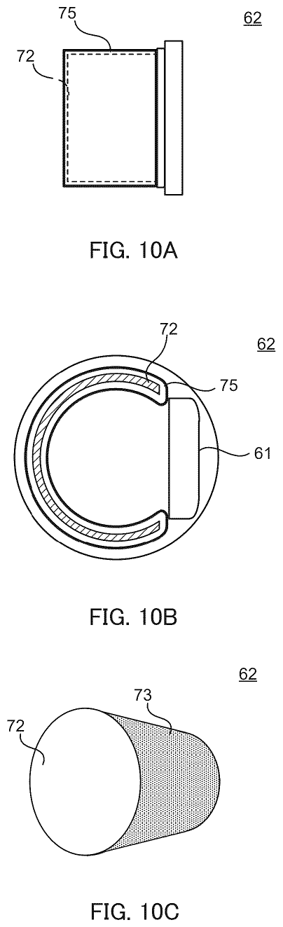

FIG. 9A and FIG. 9B are schematic diagrams illustrating a modification example of the heater holder 60 holding the heater 60, and FIG. 10A to FIG. 10C are schematic diagrams illustrating a modification example of the guide member 62. As illustrated in FIGS. 9A and 9B, the heater holder 60 includes a base material 70 and a cover member 74 that covers at least a guide surface 70a of the base material 70. As illustrated in FIG. 10A and FIG. 10B, the pair of guide members 62 includes a base material 72 including a flange portion, and a cover member 75 covering a guide surface 72a of the base material 72. The same cover members as the above-described cover member 54 can be used as the cover members 74 and 75. In FIG. 10B, hatching of the heater holder 61 is omitted for the sake of simplicity.

As shown in FIG. 10C, the guide member 62 may be a tapered member. The guide member 62 includes a tapered base material 72 and a coating layer 73. The guide member 62 is used by being inserted into the inner peripheral surface of the belt 41 so that the smaller diameter side of the tapered base material 72 is positioned on the inner side in the width direction of the belt 41 and the larger diameter side is positioned on the outer side in the width direction of the belt 41.

Further, in this embodiment, the fixing device 40A includes the heater holder 61 with the heater 60 attached thereto, but the present invention is not limited thereto.

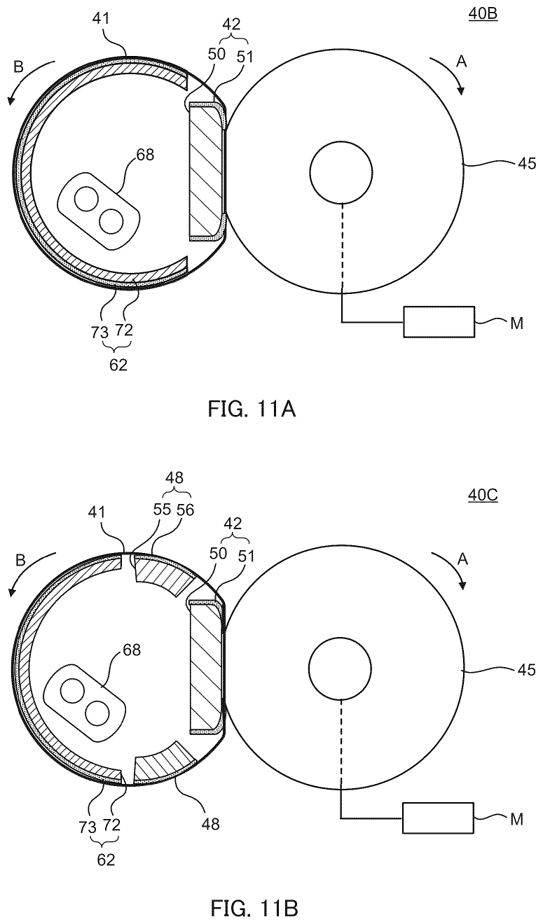

FIG. 11A and FIG. 11B are schematic diagrams illustrating a schematic configuration of fixing devices 40B and 40C according to a modification example. As illustrated in FIG. 11A, the fixing device 40B may include a heater 68 and a fixing pad 42 instead of the heater holder 61 to which the heater 60 is attached. Further, as shown in FIG. 11B, the fixing device 40C may further include two guide members 48 in addition to the heater 68 and the fixing pad 42. The fixing pad 42 includes a coating layer 51, and each of the two guide members 48 has a base material 55 and a coating layer 56. Thus, the hardness ratio L2/L1 between the hardness L2 of the guide surface of the fixing pad 42 or the guide member 48 for the belt 41 and the hardness L1 of the inner peripheral surface of the belt 41 can be adjusted to the above-described range.

In the present embodiment, the belt 41 is guided by the pair of guide members 62 (see FIG. 6), but the present invention is not limited thereto. For example, instead of the heater 60, the heater holder 61, and the guide member 62, a configuration may be adopted in which the belt 41 is wound around a heating roller (not illustrated) to guide the belt 41. In such a case, a portion of the heating roller other than the nip portion N also serves as the sliding portion on which the belt 41 slides with a lower pressure than that at the nip portion N.

### EXAMPLES

Hereinafter, the present invention will be specifically described with reference to Examples, but the present invention is not limited thereto.

### 1. Coating Material and Cover Member

### <Coating Material 1>

A coating material 1 containing polyamide-imide as a resin component, and PTFE and graphite as filler components was prepared.

### <Coating Material 2>

A coating material 2 containing polyamide-imide as a resin component and PTFE as a filler component was obtained.

### <Coating Material 3>

A coating material 3 containing a phenolic resin as a resin component and PTFE as a filler component was obtained.

### <Coating Material 4>

A coating material 4 containing the modified polyamideimide as a resin component, and PTFE, graphite, and molybdenum disulfide as filler components was obtained.

### <Cover Member>

A PEEK film (thickness: 20 μm) containing a carbon filler was prepared.

### 2. Production and Evaluation of Sliding Member

### <Test 1>

### 2-1. Production of Belt

As a endless belt, a belt in which a base layer, an elastic layer, and a surface layer were laminated in this order was prepared. The base layer was a polyimide layer containing a filler, the elastic layer was a silicone rubber layer, and the surface layer was a PFA layer.

### 2-2. Production of Sliding Member

### <Production of Sliding Member 1>

As a sliding member, the base material 52 of the guide member 43 illustrated in FIG. 4 was prepared. The materials for the base material were all composed of a material containing LCP type I and a ceramic filler.

### 2-3. Evaluation

### 2-3-1. Rockwell Hardness

After the sliding member was kept in a room at 25° C. for one day, the M-scale Rockwell hardness of the belt-side surface of the sliding member was measured in accordance with JIS K 7202-2:2001 using a Rockwell testing machine (RMT-X manufactured by Matsuzawa Corporation) at 25° C. and 65% RH. The measurement was performed by selecting any five positions at 50 mm intervals on the sliding surface and the average value thereof was used.

### 2-3-2. Torque Increase Slope

In the fixing device shown in FIG. 2 incorporating the endless belt and sliding member described above, a durability run was carried out in which the endless belt was rotated a number of times corresponding to a travel distance of 1000 km. As the lubricant, grease of PTFE base oil was used. The hardness ratio L3/L1 of the nip portion of the fixing pad was 0.8. As the frictional force between the belt and the sliding member was changed in accordance with the travel distance, the change in the rotational torque of the pressure roller by which the belt was subjected to the rotational force was measured.

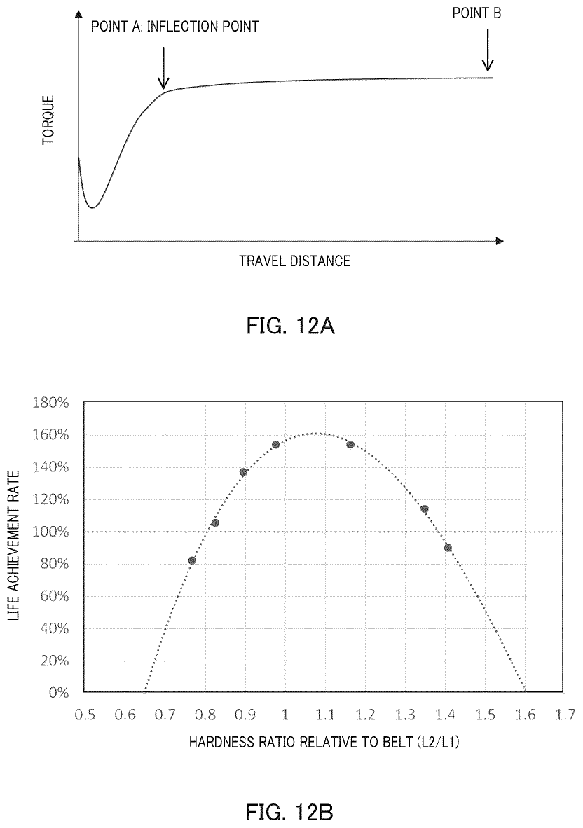

Then, in the graph as illustrated in FIG. 12A, the rotational torques at the time point A (inflection point) when the rotational torque began to stabilize and at the time point B when the travel distance reaches 1000 km were applied to the following equation, to calculate the torque increase rate.

Slope of torque increase=(torque at point B−torque at point A)/(travel distance at point B−travel distance at point A)

Then, the torque increase slope was evaluated based on the following criteria.
A: 0.5 or less of conventional slope
B: more than 0.5 and 0.7 or less of conventional slope
C: 0.7 or more and 0.8 or less of conventional slope
D: more than 0.8 of the conventional slope

### 2-3-3. Life Conversion Distance and Life Achievement Rate

In the graph shown in FIG. 12A, the travel distance when the torque value reaches the upper limit of the allowable torque range from the representative value A was calculated, and this was taken as the life conversion distance.

Life conversion distance=distance of representative value of point A+(allowable upper limit of torque−torque of representative value of point A)/torque slope

Then, the life conversion distance was evaluated based on the following criteria.
A: more than 1.5 times conventional conversion distance
B: more than 1.2 times and 1.5 times or less than conventional converted distances
C: more than 1.0 times and 1.2 times or less than a conventional converted distance
D: 1.0 times or less of conventional converted distance

### 2-3-4. Life Achievement Rate

The life achievement rate was calculated by applying the calculated life conversion distance to the following formula.

Life achievement rate (%)=life conversion distance/target life×100

### <Tests 2 and 5 to 7>

A fixing device was produced in the same manner as in Test 1 except that a sliding member was used in which a coating material shown in Table 1 was applied to the guide surface of the base material 52 of the guide member 43 and then dried to form a coating layer having a thickness of 25 μm, and the same evaluation was performed.

### <Test 3>

A fixing device was produced in the same manner as in Test 1 except that the materials of the base material 50 of the fixing pad 42 and the base material 52 of the guide member 43 as the sliding members were changed to materials containing LCP type I and glass balloons, and the same evaluation was performed.

### <Preparation of Test 4>

A fixing device was produced in the same manner as in Test 1 except that a sliding member was used in which the guide surface of the base material 52 of the guide member 43 was covered with the cover member 1 and the end portion of the cover member 1 was fixed with a tape, and the same evaluation was performed.

### 2-3-5. Evaluation Results and Discussion

The obtained evaluation results are listed in Table 1. Further, a graph showing a change in the rotational torque of the belt over time is shown in FIG. 12B.

TABLE 1

| | | | | | | | | Evaluation | | | |
|---|---|---|---|---|---|---|---|---|---|---|---|
| | | | | | | | | Torque | Life | | |
| | | | | | | | | increase | conversion | | |
| | | | | | | | | slope | distance | | |
| | Belt | | Sliding member | | | | | (ratio | (ratio | Life | |
| | Inner | Hard- | | | | Hard- | Hardness | relative to | relative to | achievement | |
| Test | peripheral | ness | | Main | | ness | ratio | conventional | conventional | rate | |
| No. | surface | LI | Form | material | Filler | L2 | (L2/L1) | value) | value) | [%] | Remarks |
| 1 | PI | 86 | Single | LCP | Ceramic | 66 | 0.767 | D (1.0) | D (1.0) | 82% | Comparative |
| | | | body | type I | filler | | | | | | example |
| 2 | | | Coating | PAI | PTFE | 71 | 0.826 | B (0.69) | B (1.28) | 105% | Example |
| | | | (coating | | Graphite | | | | | | |
| | | | material 1) | | | | | | | | |
| 3 | | | Single | LCP | Glass | 77 | 0.895 | A (0.48) | A (1.67) | 137% | Example |
| | | | body | type I | balloon | | | | | | |
| 4 | | | Cover | PEEK | Carbon | 84 | 0.977 | A (0.42) | A (1.88) | 154% | Example |
| | | | member | | | | | | | | |
| 5 | | | Coating | PAI | PTFE | 100 | 1.163 | A (0.42) | A (1.88) | 154% | Example |
| | | | (coating | | | | | | | | |
| | | | material 2) | | | | | | | | |
| 6 | | | Coating | Phenolic | PTFE | 116 | 1.349 | B (0.62) | B (1.39) | 114% | Example |
| | | | (coating | resin | | | | | | | |
| | | | material 3) | | | | | | | | |
| 7 | | | Coating | Modified | PTFE | 121 | 1.407 | D (0.82) | D (1.10) | 90% | Comparative |
| | | | (coating | PAI | graphite | | | | | | example |
| | | | material 4) | | molybdenum | | | | | | |
| | | | | | disulfide | | | | | | |

As illustrated in Table 1, it was found that in Test 1 (in which the ratio (hardness ratio L2/L1) of the Rockwell hardness L2 of the surfaces of the sliding members to the Rockwell hardness L1 of the inner peripheral surface of the belt is less than 0.8) or in Test 7 (in which the ratio is more than 1.4), the torque increase is large and the life achievement rate is also less than 100%.

On the other hand, in Tests 2 to 6 (in which the hardness ratio (L2/L1) was 0.8 or more and 1.4 or less), it was found that the torque increase was small and the life achievement rate was increased to exceed 100%.

### 3. Evaluation of Nip Portion

### 3-1. Analysis

The relationship between the ratio (hardness ratio L3/L1)—the ratio of the Rockwell hardness L3 at the nip portion of the fixing pad to the Rockwell hardness L1 of the inner peripheral surface of the belt- and the thickness margin of the belt relative to the reference thickness was analyzed by calculation using the specific wear amount. The calculation conditions were as follows.

### <Calculation Conditions>

Inner peripheral surface of belt: polyimide layer (specific wear amount 0.08×10⁻⁴ mm³/N·m).
Wear length: 1000 km
Indentation hardness: 500 MPa
Load: 500N
True contact area: 0.00000094 m²

Worn area (apparent contact area between the fixing pad and the belt in the nip portion): 43982 mm²

### <Calculation Procedure>

First, when the hardness ratio (L3/L1) was increased from 0.5 to 1.5 in increments of 0.1, the adhesive wear lengths of the belt were calculated based on Equation (1), and the abrasive wear lengths of the belt were calculated based on Equation (2).

$$Adhesive wear length of belt = specific wear amount \times hardness ratio \times wear distance \times load / worn area \qquad Equation ( 1 )$$

$$Abrasive wear length or belt = true contact area \times wear distance \times hardness ratio / worn area \qquad Equation ( 2 )$$

Next, the adhesive wear length calculated by Equation (1), the abrasive wear length calculated by Equation (2), and the reference thickness were substituted into Equation (3) to calculate the thickness margin of the belt for each hardness ratio.

$$Belt thickness margin ( \% ) = ( initial thickness - belt adhesion wear length - belt abrasive wear length of belt ) / reference thickness \times 100 \qquad Equation ( 3 )$$

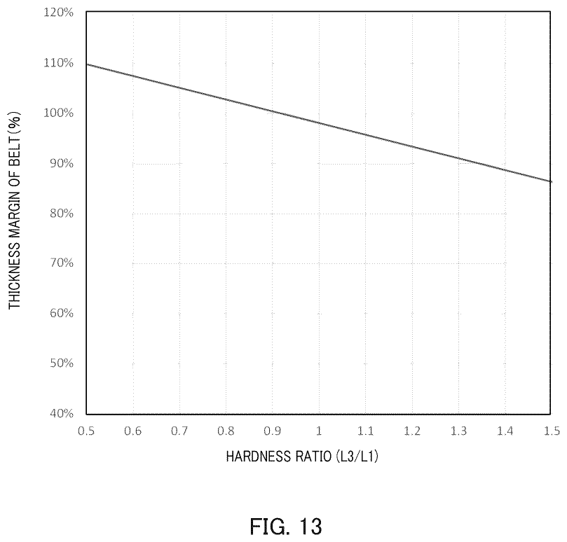

Then, for the respective hardness ratios (L3/L1), the thickness margins (%) of the belt with respect to the reference thickness were plotted to obtain a graph shown in FIG. 13. Note that the reference thickness was set to a value 1.5 times the limit thickness of the belt.

### 3-2. Analysis Results and Discussion

As shown in FIG. 13, it is found that the smaller the hardness ratio L3/L1, the higher the belt thickness margin (%). In particular, it is found that when the hardness ratio L3/L1 is less than 0.9, the belt thickness margin (%) becomes 100% or more.

### INDUSTRIAL APPLICABILITY

According to the present invention, it is possible to provide a fixing device capable of suppressing wear in a region where a belt slides under a low load and reducing an increase in rotational torque of the belt.

Although embodiments of the present invention have been described and illustrated in detail, the disclosed embodiments are made for purpose of illustration and example only and not limitation. The scope of the present invention should be interpreted by terms of the appended claims.

What is claimed is:

1. A fixing device for fixing a toner image formed on a recording medium, the fixing device comprising:
a belt that conveys the recording medium;
a support that supports the belt;
a facing member that is disposed to face the support with the belt interposed between the facing member and the support and forms a nipper that applies pressure to the belt and the recording medium between the facing member and the support; and
a slider on which the belt slides at a pressure lower than that of the nip portion, wherein
when L1 is defined as a Rockwell hardness of a surface of the belt and L2 is defined as a Rockwell hardness of a surface of the slider, a hardness ratio L2/L1 is 0.8 or more and 1.4 or less, the surface of the belt being located on a side of the slider, the surface of the slider being located on a side of the belt.

2. The fixing device according to claim 1, wherein
the slider includes a guide that guides traveling of the belt.

3. The fixing device according to claim 1, wherein
when L3 is defined as a Rockwell hardness of a portion of the support a hardness ratio L3/L1 is less than 1, the portion constituting the nipper.

4. The fixing device according to claim 3, wherein
the hardness ratio L3/L1 is 0.9 or less.

5. The fixing device according to claim 1, wherein
the slider includes a base material and a coating layer disposed on the base material.

6. The fixing device according to claim 1, wherein
the slider includes a base material and a cover disposed on the base material.
